(19) United States
(12) Patent Application Publication
(10) Pub. No.: US 2018/0307055 A1
(43) Pub. Date: Oct. 25, 2018

(54) POLARIZING BEAM SPLITTER

(71) Applicant: HON HAI PRECISION INDUSTRY CO., LTD., New Taipei (TW)

(72) Inventors: JUIN-HONG LIN, New Taipei (TW); HO-CHIANG LIU, New Taipei (TW); CHAO-TSANG WEI, New Taipei (TW)

(21) Appl. No.: 15/636,784

(22) Filed: Jun. 29, 2017

(30) Foreign Application Priority Data
Apr. 20, 2017 (CN) 201710260916.4

(51) Int. Cl. G02B 27/28

(52) U.S. Cl. CPC G02B 27/283

(57) ABSTRACT

A polarizing beam splitter comprises a main body. The main body includes a first side surface, a second side surface, a plurality of light emitting surfaces, a plurality of splitting surfaces, and a plurality of polarized beam splitter films. The second side surface is parallel to the first side surface. The plurality of light emitting surfaces is perpendicular to and connected between the first side surface and the second side surface. The light emitting surfaces are “N” in number. Each splitting surface is parallel to the others and is inclined towards the second side surface. The splitting surfaces are also “N” in number. The plurality of polarized beam splitter films are attached to the plurality of splitting surfaces, and have different reflectivities to S-polarized light of an incident light.

### FIELD

The subject matter relates to polarizing beam splitters (PBSs).

### BACKGROUND

Polarizing beam splitters are widely used to split an incident beam into two beams of differing polarization. Since the electronic product becomes smaller, a thickness of the polarizing beam splitter applied in the electronic product also needs to be decreased. However, a decrease of the thickness of polarizing beam splitter may result in a decrease of a size of a light emitting surface of the polarizing beam splitter, which may lower the light emitting efficiency of the polarizing beam splitter. Improvement in the art is preferred.

### BRIEF DESCRIPTION OF THE DRAWINGS

Implementations of the present technology will now be described, by way of example only, with reference to the attached figures, wherein:

FIG. 1 is a diagram of an exemplary embodiment of a polarizing beam splitter comprising a first splitting surface and a second splitting surface.

FIG. 2 is a diagram of a polarized beam splitter film of the polarizing beam splitter of FIG. 1.

FIG. 3 is an optical polarization diagram showing an incident light striking the first splitting surface of FIG. 1.

FIG. 4 is an optical polarization diagram showing an incident light striking the second splitting surface of FIG. 1.

FIG. 5 is a diagram of a second exemplary embodiment of the polarizing beam splitter comprising a first splitting surface, a second splitting surface, a third splitting surface, and a fourth splitting surface.

FIG. 6 is a diagram of a polarized beam splitter film of the polarizing beam splitter of FIG. 5.

FIG. 7 is an optical polarization diagram showing an incident light striking the first splitting surface of FIG. 5.

FIG. 8 is an optical polarization diagram showing an incident light striking the second splitting surface of FIG. 5.

FIG. 9 is an optical polarization diagram showing an incident light striking the third splitting surface of FIG. 5.

FIG. 10 is an optical polarization diagram showing an incident light striking the fourth splitting surface of FIG. 5.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the exemplary embodiments described herein. However, it will be understood by those of ordinary skill in the art that the exemplary embodiments described herein can be practiced without these specific details. In other instances, methods, procedures, and components have not been described in detail so as not to obscure the related relevant feature being described. Also, the description is not to be considered as limiting the scope of the exemplary embodiments described herein. The drawings are not necessarily to scale and the proportions of certain parts may be exaggerated to better illustrate details and features of the present disclosure.

One definition that applies throughout this disclosure will now be presented.

The term “comprising,” when utilized, means “including, but not necessarily limited to”; it specifically indicates open-ended inclusion or membership in the so-described combination, assembly, series and the like.

A polarizing beam splitter comprises a main body. The main body comprises a first side surface, a second side surface, a plurality of light emitting surfaces, a plurality of splitting surfaces, and a plurality of polarized beam splitter films. The second side surface is parallel to the first side surface. The plurality of light emitting surfaces is perpendicular to and connected between the first side surface and the second side surface. A number of the light emitting surfaces are defined as “N”. Each of the plurality of splitting surfaces is parallel to each other and is inclined towards the first side surface. A number of the splitting surfaces are defined as “N”. The plurality of polarized beam splitter films are attached to the plurality of splitting surfaces and having different reflectivities to S-polarized light of an incident light. Along a direction from the first side surface to the second side surface, an Mth splitting surface is defined M, has a light reflecting ratio for S-polarized light equal to 1/M, wherein N is a natural number, N>1, N≥M≥1, thereby causing the S-polarized light to be emitted out of the main body along a direction parallel to the first side surface, and an intensity of the S-polarized light emitted from each of the plurality of light emitting surfaces is 1/N of an intensity of the incident light.

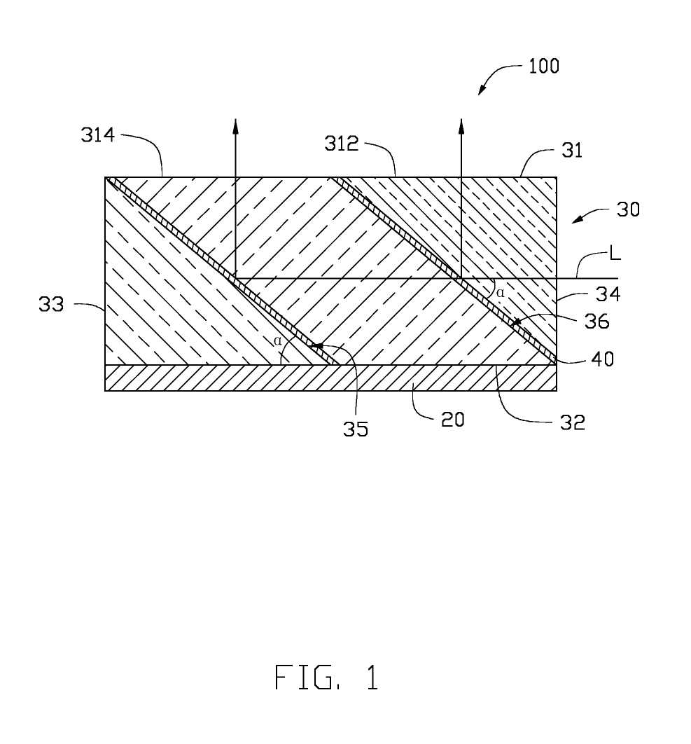

FIG. 1 illustrates a first exemplary embodiment of a polarizing beam splitter 100, which has two splitting surfaces. The number of the splitting surfaces is represented as “N”, where total of N=2.

The polarizing beam splitter 100 comprises a substrate 20 and a substantially cuboid main body 30. The main body 30 is positioned on the substrate 20. The main body 30 is made of transparent material. In the exemplary embodiment, the transparent material is glass. The main body 30 comprises an upper surface 31, a lower surface 32, a first side surface 33, a second side surface 34, a first splitting surface 35, and a second splitting surface 36.

The upper surface 31 comprises a first light emitting surface 312 and a second light emitting surface 314. The first light emitting surface 312 is connected to the second light emitting surface 314. The lower surface 32 is parallel to the upper surface 31. The lower surface 32 is positioned on the substrate 20. The first side surface 33 and the second side surface 34 are positioned at two opposite ends of the main body 30. The first side surface 33 is connected between the second light emitting surface 314 and the lower surface 32. The second side surface 34 is parallel to the first side surface 33. The second side surface 34 is connected between the first light emitting 312 and the lower surface 32. The first splitting surface 35 is parallel to the second splitting surface 36. The first splitting surface 35 and the second splitting surface 36 are inclined towards the first side surface 33. One end of the first splitting surface 35 is interconnected between the upper surface 31 and the first side surface 33. The other end of the first splitting surface 35 is connected to the lower surface 32. One end of the second splitting surface 36 is interconnected between the first light emitting surface 312 and the second light emitting surface 314. The other end of the second splitting surface 36 is interconnected between the second side surface 34 and the lower surface 32. An angle defined between the first splitting surface 35 and the upper surface 31 is labeled as “α”.

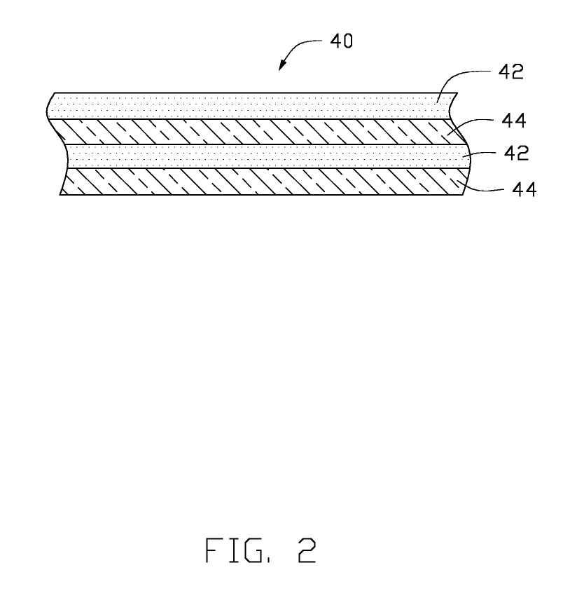

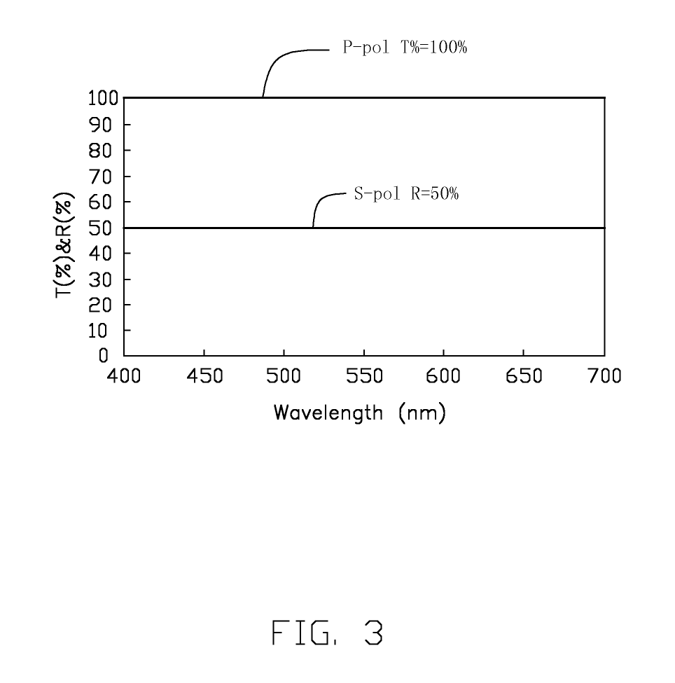

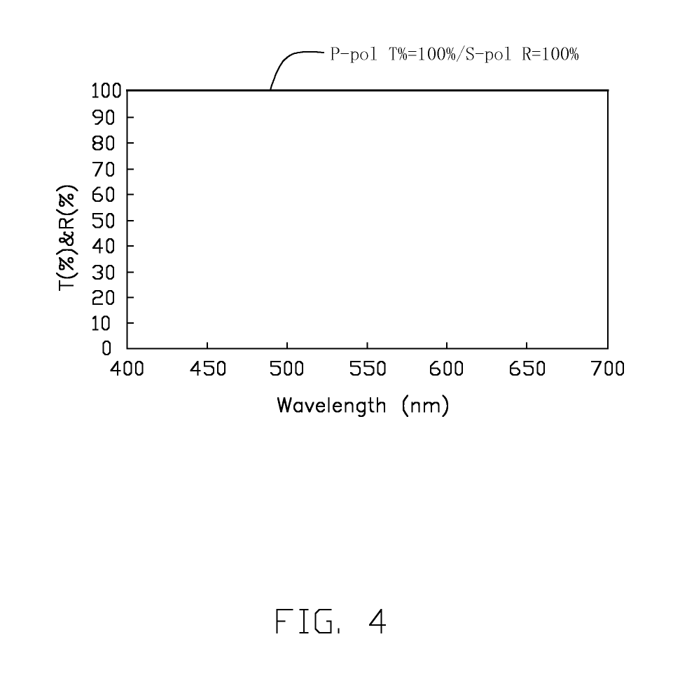

Also referring to FIG. 2, in this exemplary embodiment, a polarized beam splitter film 40 is attached to the first splitting surface 35 and the splitting surface 36 to control the reflection and penetration of the light. The polarized beam splitter film 40 comprises a plurality of penetrating films 42 and a plurality of reflective films 44 alternately arranged. Referring to FIGS. 3-4, the polarized beam splitter films 40 attached to the first splitting surface 35 and the second splitting surface 36 have different reflectivities to S-polarized light.

Referring to FIG. 3, the second splitting surface 36 has a light penetrating ratio for P-polarized light of 100%, and a light reflecting ratio for S-polarized light of 50%. Referring to FIG. 4, the first splitting surface 35 has a light penetrating ratio for P-polarized light of 100%, and a light reflecting ratio for S-polarized light of 100%.

When in use, an incident light L strikes the second splitting surface 36 from the second side surface 34 along a direction parallel to the substrate 20 as shown in FIG. 1. The incident light L has an incident angle equal to “α” with respect to the second splitting surface 36. Then, the second splitting surface 36 reflects the incident light towards the first light emitting surface 312, and allows penetration of the incident light towards the first splitting surface 35. Finally, the first splitting surface 35 reflects the incident light L towards the second light emitting surface 314, and allows penetration of the incident light towards the first side surface 33.

Because the second splitting surface 36 has a light penetrating ratio for P-polarized light of 100%, and a light reflecting ratio for S -polarized light of 50%, the first splitting surface 35 has a light penetrating ratio for P-polarized light of 100%, and a light reflecting ratio for S-polarized light of 100%, so all of the P-polarized light can directly pass the polarizing beam splitter 100 along a direction parallel to the incident light. Furthermore, the S-polarized light travels upward along a direction perpendicular to the incident light (that is, the S-polarized light is emitted out of the polarizing beam splitter 100 along a direction perpendicular to the first light emitting surface 312 and the second light emitting surface 314). The intensity of the S-polarized light from each of the first light emitting surface 312 and the second light emitting surface 314 is of 50% of the intensity of the incident light.

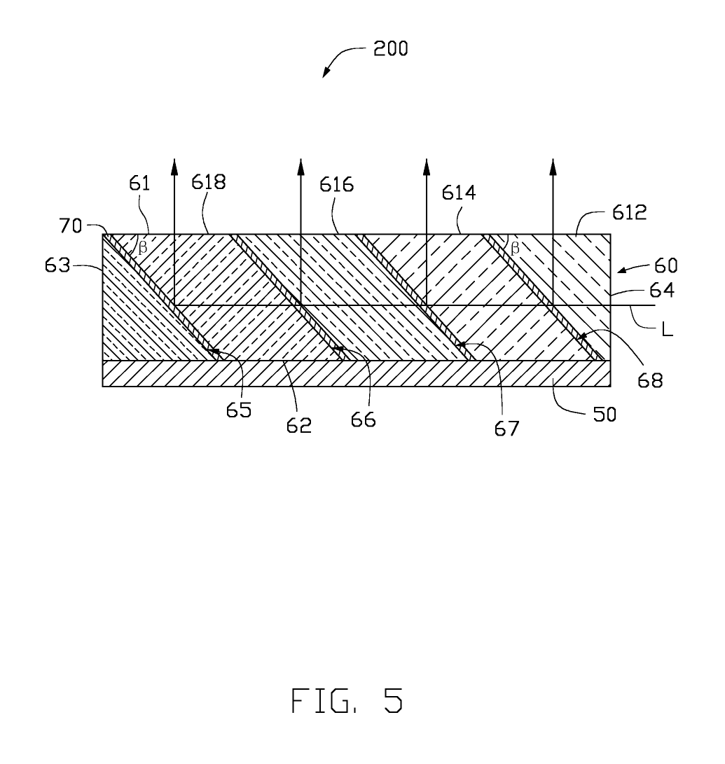

FIG. 5 illustrates a second exemplary embodiment of a polarizing beam splitter 200 that has four splitting surfaces, where total of N=4.

The polarizing beam splitter 200 comprises a substrate 50 and a substantially cuboid main body 60. The main body 60 is on the substrate 50. The main body is made of transparent material. In the exemplary embodiment, the transparent material is glass. The main body 60 comprises an upper surface 61, a lower surface 62, a first side surface 63, a second side surface 64, a first splitting surface 65, a second splitting surface 66, a third splitting surface 67, and a fourth splitting surface 68.

The upper surface 61 comprises a first light emitting surface 612, a second light emitting surface 614, a third light emitting surface 616, and a fourth light emitting surface 618. The first light emitting surface 612, the second light emitting surface 614, the third light emitting surface 616, and the fourth light emitting surface 618 are connected in order. The lower surface 62 is parallel to the upper surface 61. The lower surface 62 is positioned on the substrate 50. The first side surface 63 and the second side surface 64 are positioned at opposite ends of the main body 60. The first side surface 63 is connected between the lower surface 62 and the upper surface 61. The second side surface 64 is parallel to the first side surface 63. The first splitting surface 65, the second splitting surface 66, the third splitting surface 67, and the fourth splitting surface 68 are parallel. The first splitting surface 65, the second splitting surface 66, the third splitting surface 67, and the fourth splitting surface 68 are inclined towards the first side surface 63. One end of the first splitting surface 65 is interconnected between the fourth light emitting surface 618 and the first side surface 63. The other end of the first splitting surface 65 is connected to the lower surface 62. One end of the second splitting surface 66 is interconnected between the third light emitting surface 616 and the fourth light emitting surface 618. The other end of the second splitting surface 66 is connected to the lower surface 62. One end of the third splitting surface 67 is interconnected between the second light emitting surface 614 and the third light emitting surface 616. The other end of the third splitting surface 67 is connected to the lower surface 62. One end of the fourth splitting surface 66 is interconnected between the first light emitting surface 612 and the second light emitting surface 614. The other end the fourth splitting surface 66 is interconnected between the lower surface 62 and the second side surface 64. An angle defined between the first splitting surface 65 and the upper surface 61 is labeled as “β”.

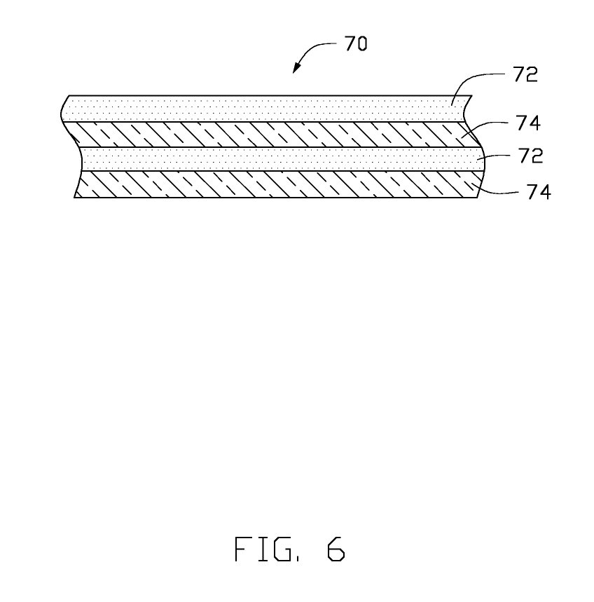

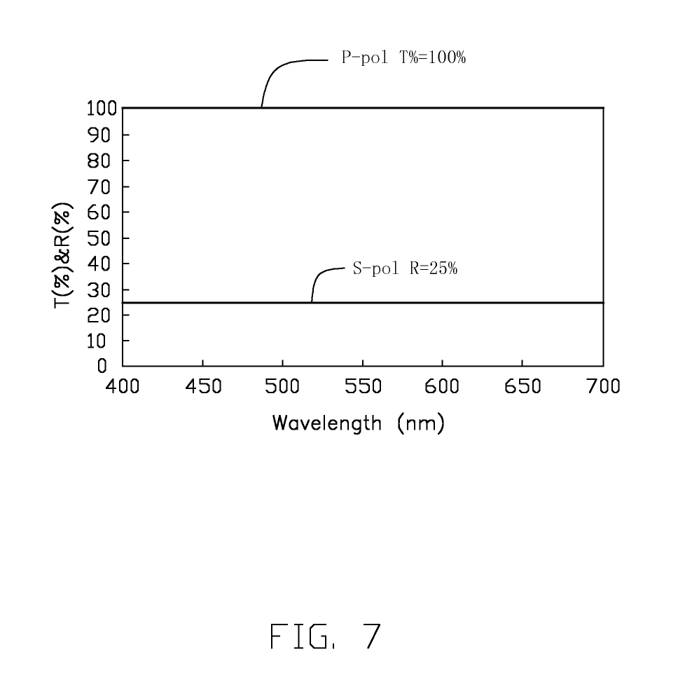

Referring to FIGS. 5-6, in this exemplary embodiment, a polarized beam splitter film 70 is attached to each of the first, the second, the third, and the fourth splitting surfaces 65, 66, 67, 68 to control the reflection and penetration of the light. The polarized beam splitter film 70 comprises a plurality of penetrating films 72 and a plurality of reflective films 74 alternately arranged. Referring to FIGS. 7-10, the polarized beam splitter films 70 attached to the first splitting surface 65, the second splitting surface 66, the third splitting surface 67, and the fourth splitting surface 68 have different reflectivities to S-polarized light.

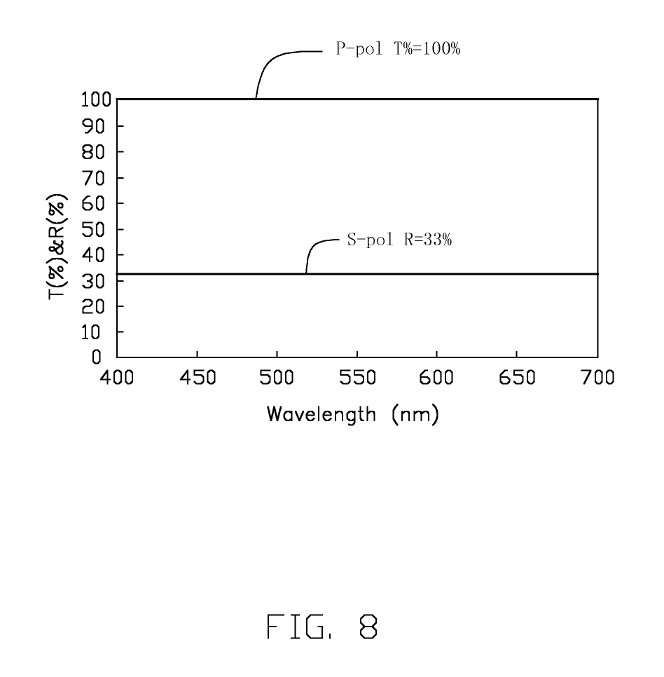

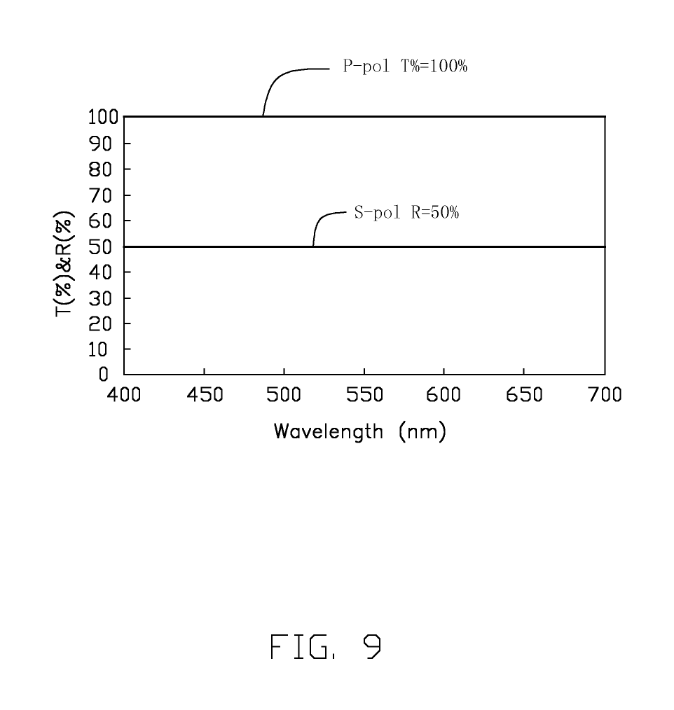

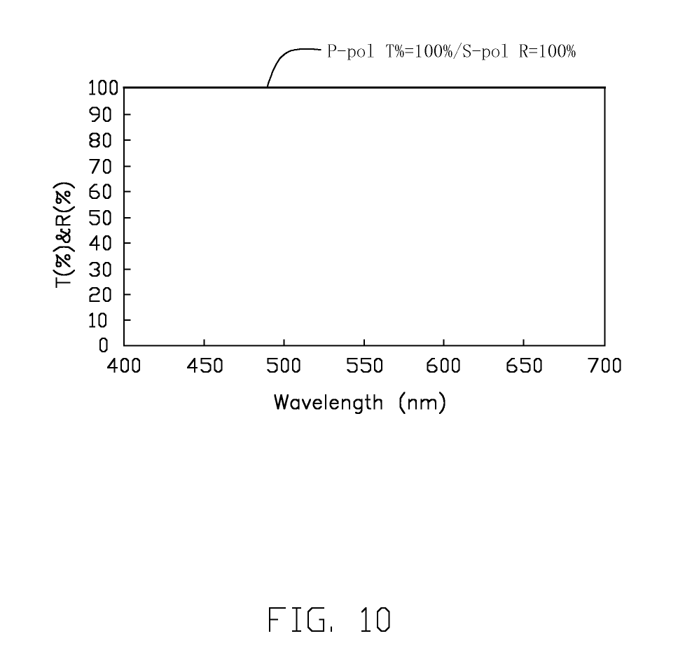

Referring to FIG. 7, the fourth splitting surface 68 has a light penetrating ratio for P-polarized light of 100%, and a light reflecting ratio for S-polarized light of 25%. Referring to FIG. 8, the third splitting surface 67 has a light penetrating ratio for P-polarized light of 100%, and a light reflecting ratio for S-polarized light of 33.3%. Referring to FIG. 9, the second splitting surface 66 has a light penetrating ratio for P-polarized light of 100%, and a light reflecting ratio for S-polarized light of 50%. Referring to FIG. 10, the first splitting surface 65 has a light penetrating ratio for P-polarized light of 100%, and a light reflecting ratio for S-polarized light of 100%.

Thus, all of the P-polarized light can directly pass the polarizing beam splitter 200 along a direction parallel to the incident light. The S-polarized light is emitted out of the polarizing beam splitter 200 along a direction perpendicular to the first light emitting surface 612, the second light emitting surface 614, the third light emitting surface 616, and the fourth light emitting surface 618. The intensity of the S-polarized light from each of the first light emitting surface 612, the second light emitting surface 614, the third light emitting surface 616, and the fourth light emitting surface 618 is of 25% of the overall intensity of the incident light.

With the above configuration, the intensity of the S-polarized light from each light emitting surface is of 1/N of the intensity of the incident light, wherein “N” represents the number of the splitting surfaces. That is, the thickness of the polarizing beam splitter can be of 1/N of the thickness of a conventional polarizing beam splitter, without changing the total intensity of the S-polarized light emitted out from the polarizing beam splitter.

The exemplary embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including, the full extent established by the broad general meaning of the terms used in the claims.

What is claimed is:

1. A polarizing beam splitter comprising:
a main body comprising:
a first side surface;
a second side surface parallel to the first side surface;
a plurality of light emitting surfaces perpendicular to and connected between the first side surface and the second side surface, and a number of the light emitting surfaces defined as N;
a plurality of splitting surfaces parallel to each other and inclined towards the first side surface, a number of the splitting surfaces defined as N; and
a plurality of polarized beam splitter films attached to the plurality of splitting surfaces and having different reflectivities to S-polarized light of an incident light;
wherein along a direction from the first side surface to the second side surface, a M^{th} polarized beam splitter film is defined as M, has a light reflecting ratio for S-polarized light equal to 1/M; wherein N is a natural number, N>1, N□M□1, thereby causing the S-polarized light to emit out of the main body along a direction parallel to the first side surface; and wherein an intensity of the S-polarized light emitted from each of the plurality of light emitting surfaces is 1/N of an intensity of the incident light.

2. The polarizing beam splitter of claim 1, wherein N=2, the main body comprises a first splitting surface and a second splitting surface.

3. The polarizing beam splitter of claim 2, wherein the second splitting surface has a light penetrating ratio for P-polarized light of 100%, and a light reflecting ratio for S-polarized light of 50%, the first splitting surface has a light penetrating ratio for P-polarized light of 100%, and a light the reflecting ratio for S-polarized light of 100%.

4. The polarizing beam splitter of claim 1, wherein N=4, the main body comprises a first splitting surface, a second splitting surface, a third splitting surface, and a fourth splitting surface.

5. The polarizing beam splitter of claim 4, wherein the fourth splitting surface has a light penetrating ratio for P-polarized light of 100%, and a light reflecting ratio for S-polarized light of 25%, the third splitting surface has a light penetrating ratio for P-polarized light of 100%, and a light reflecting ratio for S-polarized light of 33.3%, the second splitting surface has a light penetrating ratio for P-polarized light of 100%, and a light reflecting ratio for S-polarized light of 50%, the first splitting surface has a light penetrating ratio for P-polarized light of 100%, and a light reflecting ratio for S-polarized light of 100%.

6. The polarizing beam splitter of claim 1, wherein the main body is a cuboid.

7. The polarizing beam splitter of claim 1, further comprising a substrate, wherein the main body is mounted on the substrate.

8. The polarizing beam splitter of claim 1, wherein the polarized beam splitter film further comprising a plurality of penetrating films and a plurality of reflective films alternately arranged.

9. The polarizing beam splitter of claim 1, wherein the main body is made of a transparent material.

10. The polarizing beam splitter of claim 9, wherein the transparent material is glass.
